(19) United States
(12) Patent Application Publication
(10) Pub. No.: US 2006/0230097 A1
(43) Pub. Date: Oct. 12, 2006

(54) Process model monitoring method and system

(75) Inventors: Anthony J. Grichnik, Peoria, IL (US); Michael Seskin, Cardiff, CA (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/101,531

(22) Filed: Apr. 8, 2005

(51) Int. Cl. G06G 7/34

(52) U.S. Cl. 708/803

(57) ABSTRACT

A computer-implemented method is provided for monitoring model performance. The method may include obtaining configuration information and obtaining operational information about a computational model and a system being modeled. The computational model and the system may include a plurality of input parameters and one or more output parameters. The system may generate respective actual values of the one or more output parameters, and the computational model may predict respective values of the one or more output parameters. The method may also include applying an evaluation rule from a rule set, based on the configuration information, to the operational information to determine whether the rule is satisfied.

### TECHNICAL FIELD

This disclosure relates generally to computer based process modeling techniques and, more particularly, to methods and systems for monitoring performance characteristics of process models.

### BACKGROUND

Mathematical models, particularly process models, are often built to capture complex interrelationships between input parameters and output parameters. Various techniques, such as neural networks, may be used in such models to establish correlations between input parameters and output parameters. Once the models are established, they may provide predictions of the output parameters based on the input parameters. The accuracy of these models may often depend on the environment within which the models operate.

Under certain circumstances, changes in the operating environment, such as a change of design and/or a change of operational conditions, may cause the models to operate inaccurately. When these inaccuracies happen, model performance may be degraded. However, it may be difficult to determine when and/or where such inaccuracies occur. Conventional techniques, such as described in U.S. Pat. No. 5,842,202 issued to Kon on Nov. 24, 1998, use certain error models to propagate errors associated with the process. However, such conventional techniques often fail to identify model performance characteristics based on configuration or concurrently with the operation of the model.

Methods and systems consistent with certain features of the disclosed systems are directed to solving one or more of the problems set forth above.

### SUMMARY OF THE INVENTION

One aspect of the present disclosure includes a computer-implemented method for monitoring model performance. The method may include obtaining configuration information and obtaining operational information about a computational model and a system being modeled. The computational model and the system may include a plurality of input parameters and one or more output parameters. The system may generate respective actual values of the one or more output parameters, and the computational model may predict respective values of the one or more output parameters. The method may also include applying an evaluation rule from a rule set, based on the configuration information, to the operational information to determine whether the rule is satisfied.

Another aspect of the present disclosure includes a computer system. The computer system may include a database configured to store data records associated with a computational model, a plurality of input parameters and one or more output parameters. The computer system may also include a processor. The processor may be configured to obtain configuration information and to obtain operational information about the computational model from the database. The computational model and a system being modeled include the plurality of input parameters and the one or more output parameters. The system may generate respective actual values of the one or more output parameters, and the computational model may predict respective values of the one or more output parameters. The processor may be further configured to apply an evaluation rule from a rule set, based on the configuration information, to the operational information to determine whether the evaluation rule is satisfied.

Another aspect of the present disclosure includes a computer-readable medium for use on a computer system configured to perform a model optimization procedure. The computer-readable medium may include computer-executable instructions for performing a method. The method may include obtaining configuration information and obtaining operational information about a computational model and a system being modeled. The computational model and the system may include a plurality of input parameters and one or more output parameters. The system generates respective actual values of the one or more output parameters, and the computational model may predict respective values of the one or more output parameters. The method may further include applying an evaluation rule from a rule set, based on the configuration information, to the operational information to determine whether the evaluation rule is satisfied.

### BRIEF DESCRIPTION OF THE DRAWINGS

FIG. 1 is a pictorial illustration of an exemplary process modeling and monitoring environment consistent with certain disclosed embodiments;

FIG. 2 illustrates a block diagram of a computer system consistent with certain disclosed embodiments;

FIG. 3 illustrates a flowchart of an exemplary model generation and optimization process performed by a computer system;

FIG. 4 illustrates a block diagram of an exemplary process model monitor consistent with disclosed embodiments; and

FIG. 5 illustrates a flowchart of an exemplary model performance monitoring process consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

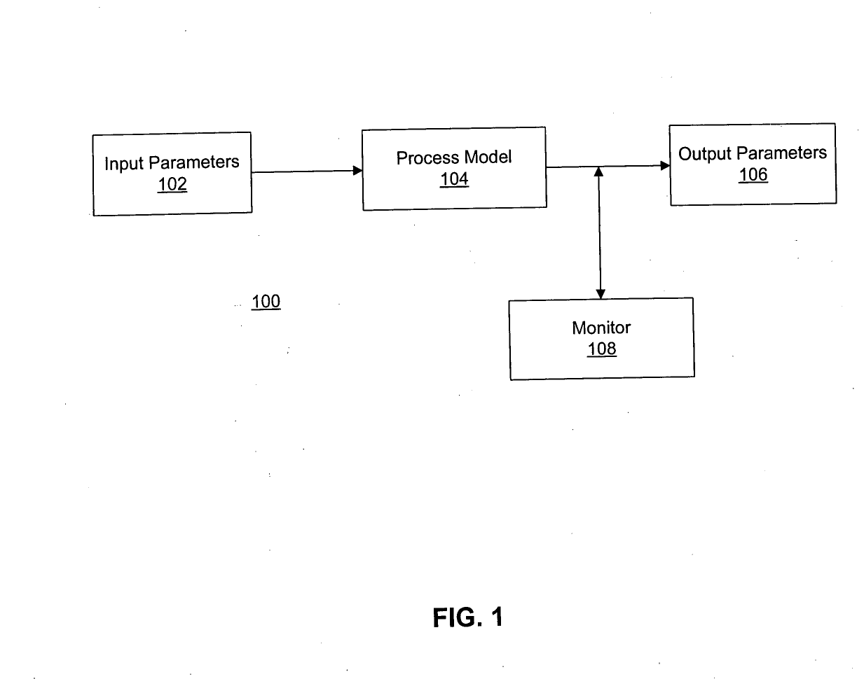

FIG. 1 illustrates a flowchart diagram of an exemplary process modeling and monitoring environment 100. As shown in FIG. 1, input parameters 102 may be provided to a process model 104 to build interrelationships between output parameters 106 and input parameters 102. Process model 104 may then predict values of output parameters 106 based on given values of input parameters 102. Input parameters 102 may include any appropriate type of data associated with a particular application. For example, input parameters 102 may include manufacturing data, data from design processes, financial data, and/or any other application data. Output parameters 106, on the other hand, may correspond to control, process, or any other types of parameters required by the particular application.

Process model 104 may include any appropriate type of mathematical or physical models indicating interrelationships between input parameters 102 and output parameters 106. For example, process model 104 may be a neural network based mathematical model that may be trained to capture interrelationships between input parameters 102 and output parameters 106. Other types of mathematic models, such as fuzzy logic models, linear system models, and/or non-linear system models, etc., may also be used. Process model 104 may be trained and validated using data records collected from the particular application for which process model 104 is generated. That is, process model 104 may be established according to particular rules corresponding to a particular type of model using the data records, and the interrelationships of process model 104 may be verified by using the data records.

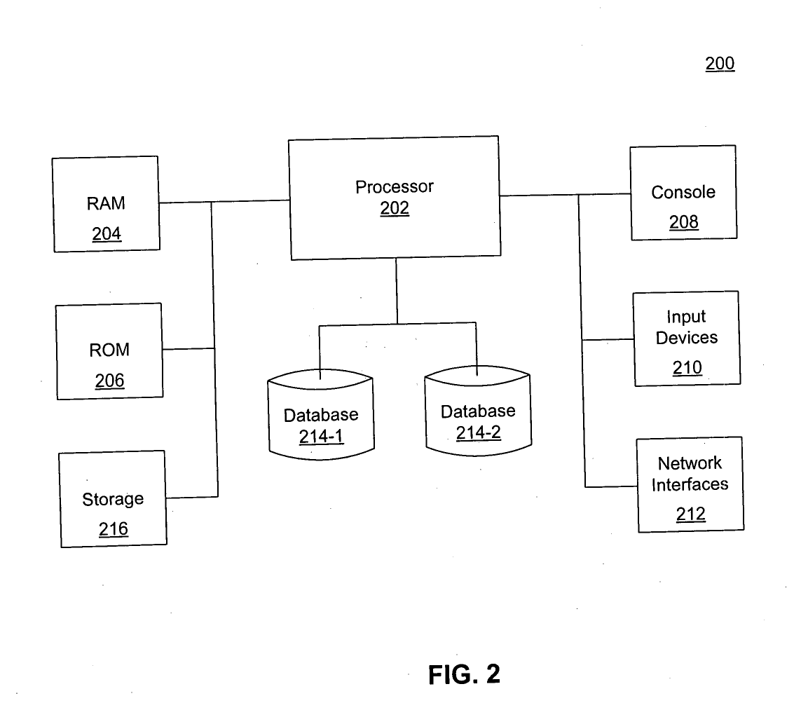

Once process model 104 is trained and validated, process model 104 may be operated to produce output parameters 106 when provided with input parameters 102. Performance characteristics of process model 104 may also be analyzed during any or all stages of training, validating, and operating. A monitor 108 may be provided to monitor the performance characteristics of process model 104. Monitor 108 may include any type of hardware device, software program, and/or a combination of hardware devices and software programs. FIG. 2 shows a functional block diagram of an exemplary computer system 200 that may be used to perform these model generation and monitoring processes.

As shown in FIG. 2, computer system 200 may include a processor 202, a random access memory (RAM) 204, a read-only memory (ROM) 206, a console 208, input devices 210, network interfaces 212, databases 214-1 and 214-2, and a storage 216. It is understood that the type and number of listed devices are exemplary only and not intended to be limiting. The number of listed devices may be changed and other devices may be added.

Processor 202 may include any appropriate type of general purpose microprocessor, digital signal processor or microcontroller. Processor 202 may execute sequences of computer program instructions to perform various processes as explained above. The computer program instructions may be loaded into RAM 204 for execution by processor 202 from a read-only memory (ROM), or from storage 216. Storage 216 may include any appropriate type of mass storage provided to store any type of information that processor 202 may need to perform the processes. For example, storage 216 may include one or more hard disk devices, optical disk devices, or other storage devices to provide storage space.

Console 208 may provide a graphic user interface (GUI) to display information to users of computer system 200. Console 208 may include any appropriate type of computer display devices or computer monitors. Input devices 210 may be provided for users to input information into computer system 200. Input devices 210 may include a keyboard, a mouse, or other optical or wireless computer input devices. Further, network interfaces 212 may provide communication connections such that computer system 200 may be accessed remotely through computer networks via various communication protocols, such as transmission control protocol/internet protocol (TCP/IP), hyper text transfer protocol (HTTP), etc.

Databases 214-1 and 214-2 may contain model data and any information related to data records under analysis, such as training and testing data. Databases 214-1 and 214-2 may include any type of commercial or customized databases. Databases 214-1 and 214-2 may also include analysis tools for analyzing the information in the databases. Processor 202 may also use databases 214-1 and 214-2 to determine and store performance characteristics of process model 104.

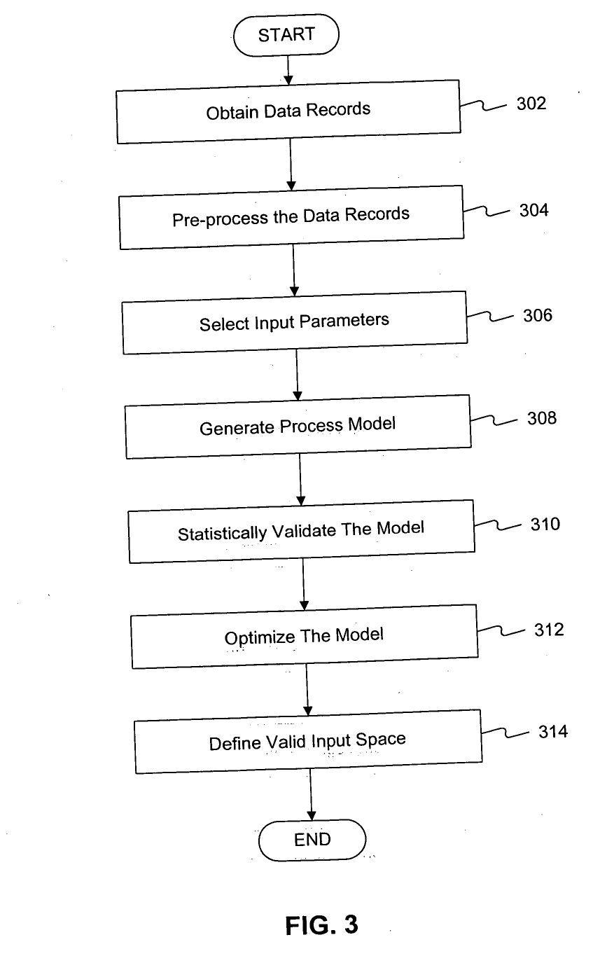

Processor 202 may perform a model generation and optimization process to generate and optimize process model 104. As shown in FIG. 3, at the beginning of the model generation and optimization process, processor 202 may obtain data records associated with input parameters 102 and output parameters 106 (step 302). For example, in an engine design application, the data records may be previously collected during a certain time period from a test engine or from electronic control modules of a plurality of engines. The data records may also be collected from experiments designed for collecting such data. Alternatively, the data records may be generated artificially by other related processes, such as a design process. The data records may also include training data used to build process model 104 and testing data used to test process model 104. In addition, data records may also include simulation data used to observe and optimize process model 104. In certain embodiments, process model 104 may include other models, such as a design model. The other models may generate model data as part of the data records for process model 104.

The data records may reflect characteristics of input parameters 102 and output parameters 106, such as statistic distributions, normal ranges, and/or tolerances, etc. Once the data records are obtained (step 302), processor 202 may pre-process the data records to clean up the data records for obvious errors and to eliminate redundancies (step 304). Processor 202 may remove approximately identical data records and/or remove data records that are out of a reasonable range in order to be meaningful for model generation and optimization. After the data records have been pre-processed, processor 202 may then select proper input parameters by analyzing the data records (step 306).

The data records may be associated with many input variables. The number of input variables may be greater than the number of input parameters 102 used for process model 104. For example, in the engine design application, data records may be associated with gas pedal indication, gear selection, atmospheric pressure, engine temperature, fuel indication, tracking control indication, and/or other engine parameters; while input parameters 102 of a particular process may only include gas pedal indication, gear selection, atmospheric pressure, and engine temperature.

In certain situations, the number of input variables in the data records may exceed the number of the data records and lead to sparse data scenarios. Some of the extra input variables may be omitted in certain mathematical models. The number of the input variables may need to be reduced to create mathematical models within practical computational time limits.

Processor 202 may select input parameters according to predetermined criteria. For example, processor 202 may choose input parameters by experimentation and/or expert opinions. Alternatively, in certain embodiments, processor 202 may select input parameters based on a mahalanobis distance between a normal data set and an abnormal data set of the data records. The normal data set and abnormal data set may be defined by processor 202 by any proper method. For example, the normal data set may include characteristic data associated with input parameters 102 that produce desired output parameters. On the other hand, the abnormal data set may include any characteristic data that may be out of tolerance or may need to be avoided. The normal data set and abnormal data set may be predefined by processor 202.

Mahalanobis distance may refer to a mathematical representation that may be used to measure data profiles based on correlations between parameters in a data set. Mahalanobis distance differs from Euclidean distance in that mahalanobis distance takes into account the correlations of the data set. Mahalanobis distance of a data set X (e.g., a multivariate vector) may be represented as
MDᵢ=(Xᵢ−μₓ)Σ⁻¹(Xᵢ−μₓ)′ (1)
where μₓ is the mean of X and Σ⁻¹ is an inverse variance-covariance matrix of X. MDᵢ weights the distance of a data point Xᵢ from its mean μₓ such that observations that are on the same multivariate normal density contour will have the same distance. Such observations may be used to identify and select correlated parameters from separate data groups having different variances.

Processor 202 may select a desired subset of input parameters such that the mahalanobis distance between the normal data set and the abnormal data set is maximized or optimized. A genetic algorithm may be used by processor 202 to search input parameters 102 for the desired subset with the purpose of maximizing the mahalanobis distance. Processor 202 may select a candidate subset of input parameters 102 based on a predetermined criteria and calculate a mahalanobis distance MDₙₒᵣₘₐₗ of the normal data set and a mahalanobis distance MD_{abnormal} of the abnormal data set. Processor 202 may also calculate the mahalanobis distance between the normal data set and the abnormal data (i.e., the deviation of the mahalanobis distance MDₓ=MDₙₒᵣₘₐₗ−MD_{abnormal}). Other types of deviations, however, may also be used.

Processor 202 may select the candidate subset of input variables 102 if the genetic algorithm converges (i.e., the genetic algorithm finds the maximized or optimized mahalanobis distance between the normal data set and the abnormal data set corresponding to the candidate subset). If the genetic algorithm does not converge, a different candidate subset of input variables may be created for further searching. This searching process may continue until the genetic algorithm converges and a desired subset of input variables (e.g., input parameters 102) is selected.

After selecting input parameters 102 (e.g., gas pedal indication, gear selection, atmospheric pressure, and temperature, etc.), processor 202 may generate process model 104 to build interrelationships between input parameters 102 and output parameters 106 (step 308). Process model 104 may correspond to a computational model. As explained above, any appropriate type of neural network may be used to build the computational model. The type of neural network models used may include back propagation, feed forward models, cascaded neural networks, and/or hybrid neural networks, etc. Particular types or structures of the neural network used may depend on particular applications. Other types of models, such as linear system or non-linear system models, etc., may also be used.

The neural network computational model (i.e., process model 104) may be trained by using selected data records. For example, the neural network computational model may include a relationship between output parameters 106 (e.g., boot control, throttle valve setting, etc.) and input parameters 102 (e.g., gas pedal indication, gear selection, atmospheric pressure, and engine temperature, etc). The neural network computational model may be evaluated by predetermined criteria to determine whether the training is completed. The criteria may include desired ranges of accuracy, time, and/or number of training iterations, etc.

After the neural network has been trained (i.e., the computational model has initially been established based on the predetermined criteria), processor 202 may statistically validate the computational model (step 310). Statistical validation may refer to an analyzing process to compare outputs of the neural network computational model with actual outputs to determine the accuracy of the computational model. Part of the data records may be reserved for use in the validation process. Alternatively, processor 202 may also generate simulation or test data for use in the validation process.

Once trained and validated, process model 104 may be used to predict values of output parameters 106 when provided with values of input parameters 102. For example, in the engine design application, processor 202 may use process model 104 to determine throttle valve setting and boot control based on input values of gas pedal indication, gear selection, atmospheric pressure, and engine temperature, etc. Further, processor 202 may optimize process model 104 by determining desired distributions of input parameters 102 based on relationships between input parameters 102 and desired distributions of output parameters 106 (step 312).

Processor 202 may analyze the relationships between desired distributions of input parameters 102 and desired distributions of output parameters 106 based on particular applications. In the above example, if a particular application requires a higher fuel efficiency, processor 202 may use a small range for the throttle valve setting and use a large range for the boost control. Processor 202 may then run a simulation of the computational model to find a desired statistic distribution for an individual input parameter (e.g., gas pedal indication, gear selection, atmospheric pressure, or engine temperature, etc). That is, processor 202 may separately determine a distribution (e.g., mean, standard variation, etc.) of the individual input parameter corresponding to the normal ranges of output parameters 106. Processor 202 may then analyze and combine the desired distributions for all the individual input parameters to determine desired distributions and characteristics for input parameters 102.

Alternatively, processor 202 may identify desired distributions of input parameters 102 simultaneously to maximize the possibility of obtaining desired outcomes. In certain embodiments, processor 202 may simultaneously determine desired distributions of input parameters 102 based on zeta statistic. Zeta statistic may indicate a relationship between input parameters, their value ranges, and desired outcomes. Zeta statistic may be represented as

$$ζ = {{\sum }_{1}}^{j} {{\sum }_{1}}^{i} \vert {S}_{ij} \vert ( \frac{{σ}_{i}}{{\overline{x}}_{i}} ) ( \frac{{\overline{x}}_{j}}{{σ}_{j}} ) ,$$

where \overline{x}ᵢ represents the mean or expected value of an ith input; \overline{x}ⱼ represents the mean or expected value of a jth outcome; σᵢ represents the standard deviation of the ith input; σⱼ represents the standard deviation of the jth outcome; and |Sᵢⱼ| represents the partial derivative or sensitivity of the jth outcome to the ith input.

Under certain circumstances, \overline{x}ᵢ may be less than or equal to zero. A value of 3σᵢ may be added to \overline{x}ᵢ to correct such problematic condition. If, however, \overline{x}ᵢ is still equal zero even after adding the value of 3σᵢ, processor 202 may determine that σᵢ may be also zero and that the process model under optimization may be undesired. In certain embodiments, processor 202 may set a minimum threshold for σᵢ to ensure reliability of process models. Under certain other circumstances, σⱼ may be equal to zero. Processor 202 may then determine that the model under optimization may be insufficient to reflect output parameters within a certain range of uncertainty. Processor 202 may assign an indefinite large number to ζ.

Processor 202 may identify a desired distribution of input parameters 102 such that the zeta statistic of the neural network computational model (i.e., process model 104) is maximized or optimized. An appropriate type of genetic algorithm may be used by processor 202 to search the desired distribution of input parameters with the purpose of maximizing the zeta statistic. Processor 202 may select a candidate set of input parameters with predetermined search ranges and run a simulation of the diagnostic model to calculate the zeta statistic parameters based on input parameters 102, output parameters 106, and the neural network computational model. Processor 202 may obtain \overline{x}ᵢ and σᵢ by analyzing the candidate set of input parameters, and obtain \overline{x}ⱼ and θⱼ by analyzing the outcomes of the simulation. Further, processor 202 may obtain {cube root}Sᵢⱼ| from the trained neural network as an indication of the impact of the ith input on the jth outcome.

Processor 202 may select the candidate set of input parameters if the genetic algorithm converges (i.e., the genetic algorithm finds the maximized or optimized zeta statistic of the diagnostic model corresponding to the candidate set of input parameters). If the genetic algorithm does not converge, a different candidate set of input parameters may be created by the genetic algorithm for further searching. This searching process may continue until the genetic algorithm converges and a desired set of input parameters 102 is identified. Processor 202 may further determine desired distributions (e.g., mean and standard deviations) of input parameters based on the desired input parameter set. Once the desired distributions are determined, processor 202 may define a valid input space that may include any input parameter within the desired distributions (314).

In one embodiment, statistical distributions of certain input parameters may be impossible or impractical to control. For example, an input parameter may be associated with a physical attribute of a device that is constant, or the input parameter may be associated with a constant variable within a process model. These input parameters may be used in the zeta statistic calculations to search or identify desired distributions for other input parameters corresponding to constant values and/or statistical distributions of these input parameters.

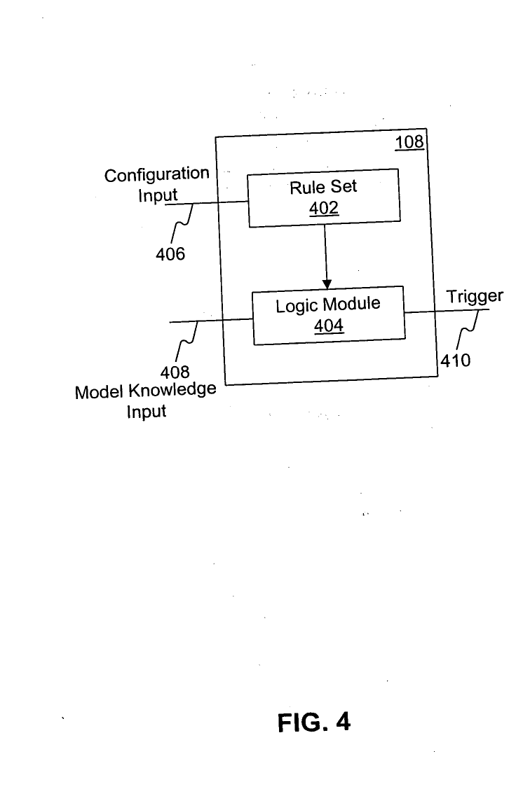

The performance characteristics of process model 104 may be monitored by monitor 108. FIG. 4 shows an exemplary block diagram of monitor 108. As shown in FIG. 4, monitor 108 may include a rule set 402, a logic module 404, a configuration input 406, a model knowledge input 408, and a trigger 410. Rule set 402 may include evaluation rules on how to evaluate and/or determine the performance characteristics of process model 104. Rule set 402 may include both application domain knowledge-independent rules and application domain knowledge-dependent rules. For example, rule set 402 may include a time out rule that may be applicable to any type of process model. The time out rule may indicate that a process model should expire after a predetermined time period without being used. A usage history of process model 104 may be obtained by monitor 108 from process model 104 to determine time periods during which process model 104 is not used. The time our rule may be satisfied when the non-usage time exceeds the predetermined time period.

In certain embodiments, an expiration rule may be set to disable process model 104 being used. For example, the expiration rule may include a predetermined time period. After process model 104 has been in use for the predetermined time period, the expiration rule may be satisfied, and process model 104 may be disabled. A user may then check process model 104 and may enable process model after checking the validity of process model 104. Alternatively, the expiration rule may be satisfied after process model 104 made a predetermined number of predictions. The user may also enable process model 104 after such expiration.

Rule set 402 may also include an evaluation rule indicating a threshold for divergence between predicted values of output parameters 106 from process model 104 and actual values corresponding to output parameters 106 from a system being modeled. The divergence may be determined based on overall actual and predicted values of output parameters 106 or based on an individual actual output parameter value and a corresponding predicted output parameter value. The threshold may be set according to particular application requirements. In the engine design example, if a predicted throttle setting deviated from an actual throttle setting value and the deviation is beyond a predetermined threshold for throttle setting, the performance of process model 104 may be determined as degraded. When the deviation is beyond the threshold, the evaluation rule may be satisfied to indicate the degraded performance of process model 104. Although certain particular rules are described, it is understood that any type of rule may be included in rule set 402.

In certain embodiments, the evaluation rule may also be configured to reflect process variability (e.g., variations of output parameters of process model 104). For example, an occasional divergence may be unrepresentative of a performance degrading, while certain consecutive divergences may indicate a degraded performance of process model 104. Any appropriate type of algorithm may be used to define evaluation rules.

Logic module 404 may be provided to apply evaluation rules of rule set 402 to model knowledge or data of process model 104 and to determine whether a particular rule of rule set 402 is satisfied. Model knowledge may refer to any information that relates to operation of process model 104. For example, model knowledge may include predicted values of output parameters 106 and actual values of output parameters 106 from a corresponding system being modeled. Model knowledge may also include model parameters, such as creation date, activities logged, etc. Logic module 404 may obtain model knowledge through model knowledge input 408. Model knowledge input 408 may be implemented by various communication means, such as direct data exchange between software programs, inter-processor communications, and/or web/internet based communications.

Logic module 404 may also determine whether any of input parameters 102 are out of the valid input space. Logic module 404 may also keep track on the number of instances of any of input parameters 102 are out of the valid input space. In one embodiment, an evaluation rule may include a predetermined number of instances of input parameters being out of the valid input space.

Trigger 410 may be provided to indicate that one or more rules of rule set 402 have been satisfied and that the performance of process model 104 may be degraded. Trigger 410 may include any appropriate type of notification mechanism, such as messages, e-mails, and any other visual or sound alarms.

Configuration input 406 may be used by a user or users of process model 104 to configure rule set 402 (e.g., to add or remove rules in rule set 402). Alternatively, configuration input 406 may be provided by other software programs or hardware devices to automatically configure rule set 402. Configuration input 406 may also include other configuration parameters for operation of monitor 108. For example, configuration input 406 may include an enable or disable command to start or stop a monitoring process. When monitor 108 is enabled, model knowledge or data may be provided to monitor 108 during each data transaction or operation from process model 104. Configuration input 406 may also include information on display, communication, and/or usages.

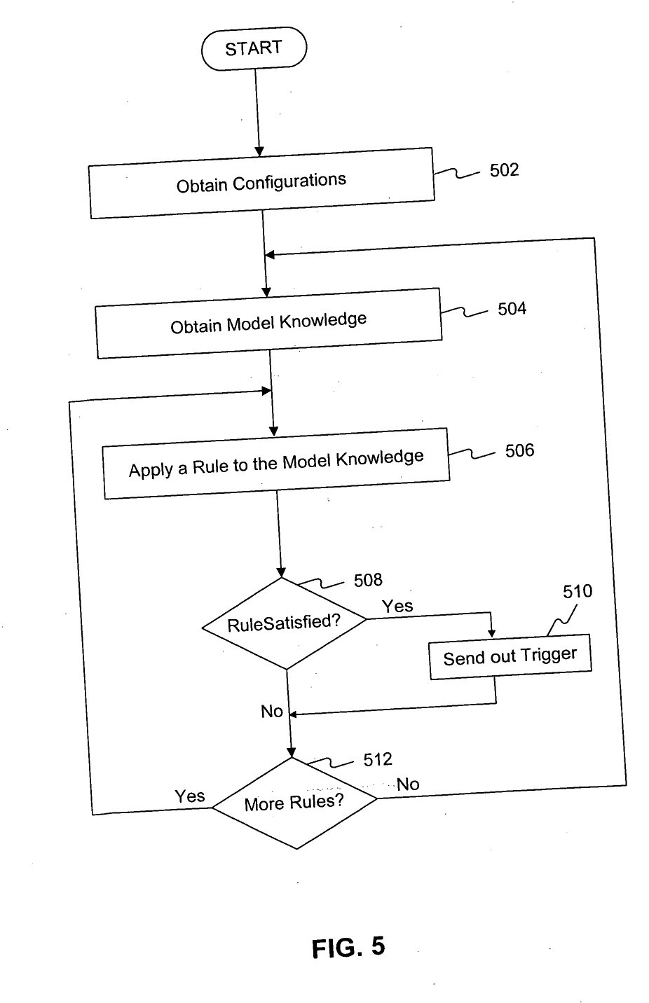

FIG. 5 shows an exemplary model monitoring process performed by processor 202. As shown in FIG. 5 processor 202 may periodically obtain configurations for monitor 108 (step 502). Processor 202 may obtain the configuration from configuration input 406. If processor 202 receives an enable configuration from configuration input 406, processor 202 may enable monitor 108. If processor 202 receives a disable configuration from configuration input 406, processor 202 may disable monitor 108 and exits the model monitoring process. Processor 202 may add all rules included in the configuration to rule set 402. For example, rule set 402 may include a monitoring rule that an alarm should be triggered if a deviation between predicted values of output parameters 106 and actual values of output parameters 106 from a system being modeled exceeds a predetermined threshold.

Processor 202 may then obtain model knowledge from model knowledge input 408 (step 504). For example, processor 202 may obtain predicted values of output parameters 106 and actual values of output parameters 106 from a system being modeled. Processor 202 may further apply the monitoring rule on the predicted values and the actual values (step 506). Processor 202 may then decide whether any rule in rule set 402 is satisfied (step 508). If processor 202 determines that a deviation between the predicted values and the actual values is beyond the predetermined threshold set in the monitoring rule (step 508; yes), processor 202 may send out an alarm via trigger 410 (step 510).

On the other hand, if the deviation is not beyond the predetermined threshold (step 508; no), processor 202 may continue the monitoring process. Processor 202 may check if there is any rule in rule set 402 that is not applied (step 512). If there are any remaining rules in rule set 402 that have not been applied (step 512; yes), processor 202 may continue applying unapplied rules in rule set 402 in step 506. On the other hand, if all rules in rule set 402 have been applied (step 512; no), processor 202 may continue the model monitoring process in step 504.

In certain embodiment, a combination of evaluation rules in rule set 402 may be used to perform compound evaluations depending on particular applications and/or particular process model 104. For example, an evaluation rule reflecting input parameters that are out of the valid input space may be used in combination with an evaluation rule reflecting deviation between the actual values and the predicted values. If processor 202 determines that input parameters 102 may be invalid as being out of the valid input space, processor 202 may determined that the predicted values may be inconclusive on determining performance of process model 104.

On the other hand, if processor 202 determines that input parameters 102 are within the valid input space, processor 202 may use the deviation rule to determine performance of process model 104 as describe above. Further, the deviation rule may include process control mechanisms to control the process variability (e.g., variation of the predicted values) as explained previously.

Alternatively, processor 202 may use an evaluation rule to determine the validity of process model 104 based on model knowledge or other simulation results independently. If processor 202 determines that process model 104 is valid, processor 202 may use the deviation rule to detect system failures outside process model 104. For example, if processor 202 determines a deviation between the predicted values and actual values, when input parameters 102 are within the valid input space and process model 104 is valid, processor 202 may determines that a system under modeling may be undergoing certain failures. Processor 202 may also determine that the failures may be unrelated to input parameters 102 because input parameters are within the valid input space.

### INDUSTRIAL APPLICABILITY

The disclosed methods and systems can provide a desired solution for model performance monitoring and/or modeling process monitoring in a wide range of applications, such as engine design, control system design, service process evaluation, financial data modeling, manufacturing process modeling, etc. The disclosed process model monitor may be used with any type of process model to monitor the model performance of the process model and to provide the process model a self-awareness of its performance. When provided with the expected model error band and other model knowledge, such as predicted values and actual values, the disclosed monitor may set alarms in real-time when the model performance declines.

The disclosed monitor may also be used as a quality control tool during the modeling process. Users may be warned when using a process model that has not been in use for a period of time. The users may also be provided with usage history data of a particular process model to help facilitate the modeling process.

The disclosed monitor may also be used together with other software programs, such as a model server and web server, such that the monitor may be used and accessed via computer networks.

Other embodiments, features, aspects, and principles of the disclosed exemplary systems will be apparent to those skilled in the art and may be implemented in various environments and systems.

What is claimed is:

1. A computer-implemented method for monitoring model performance, comprising:
obtaining configuration information;
obtaining operational information about a computational model and a system being modeled, wherein the computational model and the system include a plurality of input parameters and one or more output parameters, the system generates respective actual values of the one or more output parameters, and the computational model predicts respective values of the one or more output parameters; and
applying an evaluation rule from a rule set, based on the configuration information, to the operational information to determine whether the rule is satisfied.

2. The method according to claim 1, further including:
sending out a trigger if the evaluation rule is satisfied to indicate a decrease in a performance of the computational model.

3. The method according to claim 1, wherein the configuration information includes an enable or disable command for enabling or disabling the monitoring.

4. The method according to claim 1, wherein the computational model is created by:
obtaining data records associated with one or more input variables and the one or more output parameters;
selecting the plurality of input parameters from the one or more input variables;
generating the computational model indicative of interrelationships between the plurality of input parameters and the one or more output parameters based on the data records; and
determining desired respective statistical distributions of the plurality of input parameters of the computational model.

5. The method according to claim 4, wherein selecting further includes:
pre-processing the data records; and
using a genetic algorithm to select the plurality of input parameters from the one or more input variables based on a mahalanobis distance between a normal data set and an abnormal data set of the data records.

6. The method according to claim 4, wherein generating further includes:
creating a neural network computational model;
training the neural network computational model using the data records; and
validating the neural network computation model using the data records.

7. The method according to claim 4, wherein determining further includes:
determining a candidate set of input parameters with a maximum zeta statistic using a genetic algorithm; and
determining the desired distributions of the input parameters based on the candidate set,
wherein the zeta statistic ζ is represented by:
$$ζ = {{\sum }_{1}}^{j} {{\sum }_{1}}^{i} \vert {S}_{ij} \vert ( \frac{{σ}_{i}}{{\overline{x}}_{i}} ) ( \frac{{\overline{x}}_{j}}{{σ}_{j}} ) ,$$
provided that \overline{x}ᵢ represents a mean of an ith input; \overline{x}ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

8. The method according to claim 1, wherein applying includes:
determining a divergence between the predicted values of the one or more output parameters from the computational model and the actual values of the one or more output parameters from the system;
determining whether the divergence is beyond a predetermined threshold; and
determining that a decreased performance condition of the computational model exists if the divergence is beyond the threshold.

9. The method according to claim 1, wherein applying includes:
determining a divergence between the predicted values of the one or more output parameters from the computational model and the actual values of the one or more output parameters from the system;
determining whether the divergence is beyond a predetermined threshold;
recording a number of occurrences of the divergence being beyond the predetermined threshold; and
determining that a decreased performance condition of the computational model exists if the number of occurrences of the divergence is beyond a predetermined number.

10. The method according to claim 1, wherein applying includes:
determining a time period for the computational model;
determining whether the time period is beyond a predetermined threshold; and
determining whether an expiration condition of the computational model exists if the time period is beyond the threshold.

11. The method according to claim 1, wherein the operational information includes at least:
the actual values of the one or more output parameters,
the predicted values of the one or more output parameters; and
a usage history including a time period during which the computational model is not used.

12. A computer system, comprising:
a database configured to store data records associated with a computational model, a plurality of input parameters, and one or more output parameters; and
a processor configured to:
obtain configuration information;
obtain operational information about the computational model from the database, wherein the computational model and a system being modeled include the plurality of input parameters and the one or more output parameters, the system generates respective actual values of the one or more output parameters, and the computational model predicts respective values of the one or more output parameters; and
apply an evaluation rule from a rule set, based on the configuration information, to the operational information to determine whether the evaluation rule is satisfied.

13. The computer system according to claim 12, wherein the processor is further configured to:
send out a trigger if the evaluation rule is satisfied to indicate a decrease in a performance of the computational model.

14. The computer system according to claim 12, wherein the computational model is created by:
obtaining data records associated with one or more input variables and the one or more output parameters;
selecting the plurality of input parameters from the one or more input variables;
generating the computational model indicative of interrelationships between the plurality input parameters and the one or more output parameters based on the data records; and
determining desired respective statistical distributions of the plurality of input parameters of the computational model.

15. The computer system according to claim 14, wherein selecting further includes:
pre-processing the data records; and
using a genetic algorithm to select the plurality of input parameters from one or more input variables based on a mahalanobis distance between a normal data set and an abnormal data set of the data records.

16. The computer system according to claim 14, wherein determining further includes:
determining a candidate set of input parameters with a maximum zeta statistic using a genetic algorithm; and
determining the desired statistical distributions of the input parameters based on the candidate set,
wherein the zeta statistic ζ is represented by:
$$ζ = {{\sum }_{1}}^{j} {{\sum }_{1}}^{i} \vert {S}_{ij} \vert ( \frac{{σ}_{i}}{{\overline{x}}_{i}} ) ( \frac{{\overline{x}}_{j}}{{σ}_{j}} ) ,$$
provided that \overline{x}ᵢ represents a mean of an ith input; \overline{x}ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

17. The computer system according to claim 12, wherein, to apply the evaluation rule, the processor is further configured to:
determine a divergence between the predicted values of the one or more output parameters from the computational model and the actual values of the one or more output parameters from the system;
determine whether the divergence is beyond a predetermined threshold; and
determine that a decreased performance condition of the computational model exists if the divergence is beyond the threshold.

18. The computer system according to claim 12, wherein, to apply the evaluation rule, the processor is further configured to:
determine a time period during which the computational model has not been used;
determine whether the time period is beyond a predetermined threshold; and
determine whether an expiration condition of the computational model exists if the time period is beyond the threshold.

19. A computer-readable medium for use on a computer system configured to perform a model monitoring procedure, the computer-readable medium having computer-executable instructions for performing a method comprising:
obtaining configuration information;
obtaining operational information about a computational model and a system being modeled, wherein the computational model and the system include a plurality of input parameters and one or more output parameters, the system generates respective actual values of the one or more output parameters, and the computational model predicts respective values of the one or more output parameters; and
applying an evaluation rule from a rule set, based on the configuration information, to the operational information to determine whether the evaluation rule is satisfied.

20. The computer-readable medium according to claim 19, wherein the method further includes:
sending out a trigger to indicate a decrease in a performance of the computational model if the evaluation rule is satisfied.

21. The computer-readable medium according to claim 19, wherein applying further includes:
determining a divergence between the predicted values of the one or more output parameters from the computational model and the actual values of the one or more output parameters from the system;
determining whether the divergence is beyond a predetermined threshold; and
determining that a decreased performance condition of the computational model exists if the divergence is beyond the threshold.

22. The computer-readable medium according to claim 19, wherein applying further includes:
determining a time period during which the computational model has not been used;
determining whether the time period is beyond a predetermined threshold; and
determining whether an expiration condition of the computational model exists if the time period is beyond the threshold.

23. The computer-readable medium according to claim 19, wherein the operational information includes at least:
the actual values of the one or more output parameters;
the predicted values of the one or more output parameters; and
a usage history including a time period during which the computational model is not used.
